(19) United States
(12) Patent Application Publication
(10) Pub. No.: US 2026/0201814 A1
(43) Pub. Date: Jul. 16, 2026

(54) TURBINE ENGINE COMPRISING AN IMMOBILIZING MAGNETIC COUPLING DEVICE

(71) Applicant: SAFRAN HELICOPTER ENGINES, Bordes (FR)

(72) Inventors: Stéphane Albert André DOUILLARD, MOISSY-CRAMAYEL (FR); Stéphane Meyer BEDDOK, MOISSY-CRAMAYEL (FR); Alexandre AUDUBERTEAU, MOISSY-CRAMAYEL (FR); Mathieu Pierre CLADIERE, MOISSY-CRAMAYEL (FR)

(73) Assignee: SAFRAN HELICOPTER ENGINES, Bordes (FR)

(21) Appl. No.: 19/134,866

(22) PCT Filed: Dec. 4, 2023
(86) PCT No.: PCT/FR2023/051914

§ 371 Date: Jun. 2, 2025

(30) Foreign Application Priority Data
Dec. 5, 2022 (FR) FR2212737

(51) Int. Cl. F01D 21/00; H02K 49/10

(52) U.S. Cl. CPC F01D 21/006; H02K 49/106; H02K 49/108; F05D 2220/323; F05D 2260/903

(57) ABSTRACT

A turbine engine for an aircraft includes a rotating element rotatably mounted in a structural element and configured to generate thrust during rotation thereof. The turbine engine further includes controlled means for immobilizing the rotating element with respect to the structural element. The controlled immobilization means are formed by a magnetic coupling device that include a rotor that is coupled with the rotating element and comprises first magnetic elements; and a stator which is stationary with respect to the structural element and second magnetic elements. The magnetic coupling device is controlled between an inoperative state, in which the rotor is free to rotate with respect to the stator, and an operative state, in which the rotor is rotatably immobilized by an immobilization resisting torque.

### TECHNICAL FIELD OF THE INVENTION

The invention relates to a turbine engine for an aircraft comprising:
a structural element;
a rotating element with blades or vanes rotatably mounted in the structural element, designed to generate thrust as it rotates;
propulsion means which drive the rotating element in rotation;
means for braking the rotation of the rotating element formed by an electric braking motor;
controlled means for immobilizing the rotating element relative to the structural element.

### TECHNICAL BACKGROUND

The prior art comprises in particular the documents US 2017/260872 A1 and FR 3 109 766 A1.

The aeronautical turbine engines drive rotating elements that allow thrust to be generated. Depending on the type of turbine engine under consideration, the rotating element may have different configurations. According to non-limiting examples, the rotating element is formed by a rotor with blades for a helicopter, or it is formed by a compressor wheel for a turbojet engine, or it is formed by a propeller for a turboprop engine, etc.

During certain specific phases of aircraft use, these rotating elements may need to be slowed down and/or stopped and/or kept at a standstill.

According to a first example of such a specific phase of use, this need may arise in particular to facilitate passenger boarding or alighting while keeping the engines running.

According to another example of such a specific phase of use, the turbine engine can be kept running to draw electric or pneumatic power from the turbine engine without driving the rotor.

According to yet another example of such a specific phase of use, when the aircraft is on the tarmac with the engine switched off, there is a risk that the wind will cause the blades of the rotor to rotate. The aim is therefore to immobilize the blades of the rotor and the power turbine of the engine.

The known technical solutions for performing the braking and immobilization functions of rotating thrust-generating elements are hydraulically or electrically actuated disc brakes mounted on the shaft line between the engine of the turbine engine and the rotating element to be braked.

The conventional disc brake systems work by friction between parts. However, the friction parts wear out quickly as they are used. They therefore need to be changed frequently. This therefore generates costs for purchasing parts as well as costs for the immobilization and regular maintenance of the aircraft.

### SUMMARY OF THE INVENTION

The invention relates to a turbine engine for an aircraft comprising:
a structural element;
a rotating element with blades or vanes rotatably mounted in the structural element, designed to generate thrust as it rotates;
propulsion means which drive the rotating element in rotation;
means for braking the rotation of the rotating element formed by an electric braking motor;
controlled means for immobilizing the rotating element relative to the structural element.

The turbine engine according to the invention is characterized in that the controlled immobilization means are formed by a magnetic coupling device which is separate from the electric braking motor and which comprises:
a rotor which is mounted so as to rotate about an axis of rotation, which is coupled to the rotating element, and which comprises first magnetic elements;
a stator which is mounted so as to be fixed in rotation about said axis of rotation with respect to the structural element, and which comprises second magnetic elements;
the magnetic coupling device being controlled between an inactive state in which the rotor is free to rotate relative to the stator and an active state in which the rotor is immobilized in rotation by an immobilizing resistive torque produced by magnetic interaction between the first magnetic elements and the second magnetic elements.

According to another aspect of the invention, in the active state, the first magnetic elements are separated from the second magnetic elements by an air gap.

According to another aspect of the invention, the first magnetic elements of the rotor are formed by permanent magnets.

According to another aspect of the invention, the second magnetic elements of the stator are formed by permanent magnets.

According to another aspect of the invention, the stator is mounted to slide with respect to the rotor in the direction of the axis of rotation between:
a spaced apart position, corresponding to its inactive state, wherein the first magnetic elements are sufficiently separated from the second magnetic elements for the resistive immobilization torque to be substantially zero; and
a close position, corresponding to its active state, wherein the first magnetic elements are sufficiently close for the immobilising resistive torque to immobilize the rotating element relative to the structural element.

According to another aspect of the invention, the first magnetic elements are arranged radially opposite the second magnetic elements when the magnetic coupling device is in its active state.

According to another aspect of the invention, one of the stator or the rotor is configured to be received concentrically in the other of the stator or the rotor in the active state of the magnetic coupling device with reservation of a radial air gap, the first magnetic elements and the second magnetic elements each being arranged in a ring gear around the axis of rotation, with their polarity alternating.

According to another aspect of the invention, the first magnetic elements are arranged axially opposite the second magnetic elements when the magnetic coupling device is in its active state.

According to another aspect of the invention, the rotor and stator are in the form of axially facing flanges, the first magnetic elements and the second magnetic elements each being arranged regularly around the axis of rotation in the face facing the other flange.

According to another aspect of the invention, the electric braking motor forms the propulsion means.

### BRIEF DESCRIPTION OF THE FIGURES

Further characteristics and advantages of the invention will become apparent from the following detailed description, for the understanding of which reference is made to the attached drawings.

FIG. 1 is a schematic axial cross-sectional view of a turboprop engine produced in accordance with the teachings of the invention.

FIG. 2 is an axial cross-sectional view showing a transmission housing of the turboprop engine of FIG. 1 which comprises a magnetic coupling device for securing a propeller of the turboprop engine, the magnetic coupling device being in an inactive state.

FIG. 3 is a similar view to FIG. 2, in which an electric braking motor supplies braking torque to the propeller.

FIG. 4 is a similar view to FIG. 2, in which the magnetic coupling device is in an active state, with the propulsion means of the turboprop engine at a standstill.

FIG. 5 is a similar view to FIG. 2, in which the magnetic coupling device is in an active state, with the propulsion means of the turboprop engine in operation.

FIG. 6 is an axial sectional view showing the magnetic coupling device of FIG. 2 in a first embodiment of the invention, with the magnetic coupling device in its active state.

FIG. 7 is a cross-sectional view showing the magnetic coupling device of FIG. 6 in its active state.

FIG. 8 is an axial sectional view showing the magnetic coupling device of FIG. 2 in a second embodiment of the invention, with the magnetic coupling device in its active state.

FIG. 9 is a front view showing a rotor of the magnetic coupling device shown in FIG. 8.

### DETAILED DESCRIPTION OF THE INVENTION

In the following description, elements with an identical structure or similar functions will be referred to by a same reference.

In the remainder of the description, an axial orientation directed from front to back and parallel to the axis “E” of rotation of the rotor of a magnetic coupling device will be adopted.

A radial orientation shall be used, which is directed orthogonally to the axial direction and from the inside towards the outside in the vicinity of a specified axis of rotation. We also use a circumferential direction which is orthogonal to a radial direction and to the longitudinal direction.

In the remainder of the description, each magnetic element will have two opposing magnetic poles which will be designated by the letters “N” and “S” in the figures.

The invention concerns a turbine engine 10 for an aircraft.

The turbine engine 10 can be fitted to an aircraft with vertical take-off and landing, such as a helicopter. In this respect, the aircraft comprises a turbine engine, known as a “lift” engine, which is designed to generate vertical thrust to lift the aircraft. The turbine engine 10 can also be a propulsion turbine engine, which is designed to generate longitudinal thrust to enable the aircraft to move forward.

In general, such a turbine engine 10 comprises a structural element 12 which is mounted on the aircraft. It also comprises a rotating element 14 with blades or vanes mounted so that it can rotate about an axis “A” in the structural element 12. The rotating element 14 generally comprises a hub 16 from which a plurality of blades 18 or vanes extend radially. The blades 18 or the vanes are evenly spaced around the hub 16 with a specific angular pitch.

More specifically, the rotating element 14 comprises an output shaft 20 which, with axis “A”, is rotatably mounted in the structural element 12 by means of guide bearings.

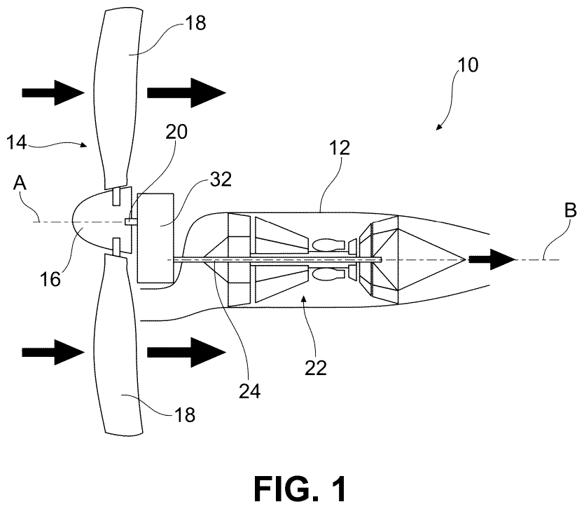

FIG. 1 shows a non-limiting example of a turbine engine 10 formed by a turboprop engine. The rotating element 14 is formed by a propeller with blades 18 extending from a hub 16 or by a helicopter rotor. The structural element 12 can then be formed by a nacelle or by the structure of the aircraft itself.

In a variant of the invention not shown, the turbine engine can also be a turbojet engine. In this case, the rotating element 14 is formed by a fan, which may or may not be ducted, and the structural element 12 is formed by a sleeve.

The turbine engine 10 also comprises propulsion means 22 that drive the rotating element 14. The propulsion means 22 rotate an input shaft 24 with an axis “B”, which is intended to be rotatably connected to the output shaft 20 to rotate the rotating element 14.

The propulsion means 22 can be formed by a thermal engine by a turbine or by an electric motor.

In the example shown in FIG. 1, the propulsion means 22 are formed by at least one gas turbine stage.

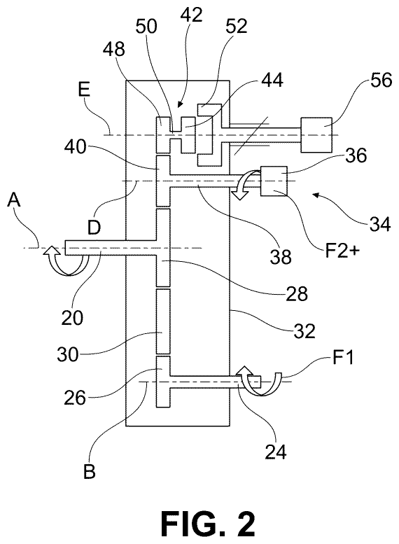

In the embodiment shown in FIGS. 2 to 5, the torque of the input shaft 24 is transmitted to the output shaft 20 via a gear train.

In the non-limiting example shown in FIG. 2, the input shaft 24 is fitted with an input pinion 26 which is secured in rotation with the input shaft 24. The output shaft 20 is fitted with an output pinion 28, which is secured in rotation with the output shaft 20. The gear train here comprises an intermediate pinion 30 which meshes with the input pinion 26, on the one hand, and with the output pinion 28, on the other. The intermediate pinion 30 is mounted so that it can rotate about an axis “C”. The input shaft 24 thus drives the input pinion 26 in rotation, which in turn drives the intermediate pinion 30 by meshing. The intermediate pinion 30 in turn drives the output pinion 28, and thus the output shaft 20, in rotation.

The gear train is arranged here in a transmission housing 32.

The turbine engine 10 further comprises braking means 34 for slowing down or even stopping the rotation of the rotating element 14 relative to the structural element 12. In fact, when the propulsion means 22 are stopped, the rotating element 14 is likely to continue its rotation under the effect of inertia. The braking means 34 thus allow the time required for the rotating element 14 to come to a complete stop to be reduced.

The braking means 34 are formed by an electric motor 36, hereinafter referred to as the “electric braking motor 36”. It may be a DC electric motor or an AC motor of the synchronous, asynchronous or variable reluctance type. Such an electric braking motor 36 has the advantage of being able to slow down the rotating element 14 by applying a braking torque to its rotation.

Preferably, the braking means 34 are not formed by a synchronous stepper motor. It is not always necessary to benefit from the advantages of such an electric motor, which is very expensive.

Alternatively, when it is necessary to stop the rotating element 14 in a given angular position, the braking means 34 are formed by a synchronous stepper motor.

The electric braking motor 36 is separate from the propulsion means 22.

In both cases, the electric braking motor 36 is arranged in parallel with the propulsion engine, for example. The electric braking motor 36 rotates a brake shaft 38 with axis “D,” which is connected in rotation to the output shaft 20 via a gear train.

In the non-limiting example shown in the figures, the braking shaft 38 is fitted with a braking pinion 40 which is fixed in rotation with the braking shaft 38. The braking pinion 40 is directly meshed with the output pinion 28. The brake input shaft 24 thus transmits torque to the output pinion 28. The brake pinion 40 is located in the transmission housing 32.

In this configuration, the electric braking motor 36 can be used to apply a braking torque which opposes the rotation of the rotating element 14. In this case, the electric braking motor 36 slows or even stops the rotation of the rotating element 14.

The electric braking motor 36 can also be used to provide torque to rotate the rotating element 14 to assist and/or replace the propulsion engine.

In another variant, the electric braking motor 36 also forms the propulsion means 22. In this way, the same electric motor performs both propulsion and braking functions.

In all cases, the turbine engine 10 advantageously comprises controlled means for immobilising the rotating element 14 in rotation with respect to the structural element 12. This prevents the rotating element 14 from rotating when necessary, as mentioned in the preamble.

The invention proposes means of immobilization formed by a magnetic coupling device 42 in order to immobilize the rotating element 14 without the need to electrically power the electric brake and/or propulsion engines 36. In addition to the energy that this involves consuming to immobilise the rotating element 14, the continuous power supply to an electric motor over time risks causing certain electrical or electronic components to overheat, resulting in premature wear of these components.

Such a magnetic coupling device 42 is separate from the electric braking motor 36 and is separate from the propulsion engine when the latter is formed by an electric motor.

Such a magnetic coupling device 42 comprises a rotor 44 which is mounted so as to rotate about an axis “E” of rotation. The rotor 44 is linked in rotation with the rotating element 14. The rotor 44 has first magnetic elements 46.

The rotor 44 is linked in rotation with the output shaft 20 via a gear train. The gear train has a specific transmission ratio “r”.

In the non-limiting example shown in the figures, the rotor 44 is locked in rotation with a locking pinion 48 via a locking shaft 50 coaxial with the axis “E” of rotation. The locking pinion 48 is directly meshed with the braking pinion 40. The rotor 44 thus immobilises the output pinion 28 via the braking pinion 40. The rotor 44 and the locking pinion 48 are arranged in the transmission housing 32.

The magnetic coupling device 42 also comprises a stator 52 which is mounted so as to be fixed in rotation about the said axis “E” of rotation with respect to the structural element 12. The stator 52 comprises second magnetic elements 54.

Without limitation, the stator 52 is arranged here in the transmission housing 32.

The magnetic coupling device 42 is controlled between an inactive state in which the rotor 44 is free to rotate relative to the stator 52 and an active state in which the rotor 44 is immobilized in rotation relative to the stator 52 by a high immobilization torque “Ci” resisting immobilization produced by contactless magnetic interaction between the first magnetic elements 46 and the second magnetic elements 54.

Such a resisting immobilization torque “Ci” is defined as a torque which opposes the rotation of the rotor 44 in both directions about its axis of rotation “E”.

More specifically, the magnetic interaction involves magnetic attraction forces that attract a first magnetic element 46 and an associated second magnetic element 54, as well as magnetic repulsion forces, as will be explained later.

The rotor 44 remains immobilised until a torque greater than a slip torque “Cg” is applied to the rotor 44 in either direction. When a torque greater than or equal to the slip torque “Cg” is applied to the rotor 44, this torque overcomes the resistive holding torque “Ci”, causing the rotor 44 to rotate relative to the stator 52. This sliding torque “Cg” depends in particular on the properties of the magnetic elements used, especially the strength of the magnetic field they emit.

The use of a gear train to link the rotating rotor 44 to the output shaft 20 makes it possible to reduce the sliding torque “Cg” by configuring the gear train with a specific transmission ratio “r”.

For example, consider a magnetic coupling device 42 configured with a sliding torque “Cg” of 40 N·m. When the transmission ratio “r” is 10 between the output pinion 28 considered as a driving wheel and the immobilization pinion 48 considered as a driven wheel, the torque applied by the rotating element 14 to the rotor 44 is divided by 10. Thus, if a torque of 100 N·m is applied to the rotating element 14, for example by the wind, the rotor 44 will only be subjected to a drive torque of 10 N·m which is less than the slip torque “Cg”, whereas in the absence of this transmission ratio “r”, this drive torque would exceed the slip torque “Cg”.

In one variant, the rotor 44 is carried directly by the output shaft 20. However, this configuration does not allow the transmission ratio “r” to be used to reduce the sliding torque “Cg”, as is the case when the rotor 44 is connected to the output shaft 20 via a gear train.

In another variant, the rotor 44 is carried directly by the input shaft 24. However, this configuration does not allow the transmission ratio “r” to be used to reduce the sliding torque “Cg”, as is the case when the rotor 44 is connected to the output shaft 20 via a gear train.

In this case, the input shaft 24, the braking shaft 38, the output shaft 20 and the immobilization shaft 50 are arranged parallel to each other.

This is a synchronous magnetic coupling device 42.

Preferably, the first magnetic elements 46 of the rotor 44 are permanent magnets. Similarly, the second magnetic elements 54 of the stator 52 are formed by permanent magnets. Each magnetic element 46, 54 can be made by a single magnet or by assembling several magnets.

This configuration allows to obtain a magnetic coupling device 42 which does not consume energy when it immobilises the rotating element 14. In addition, such a magnetic coupling device 42 is virtually wear-free.

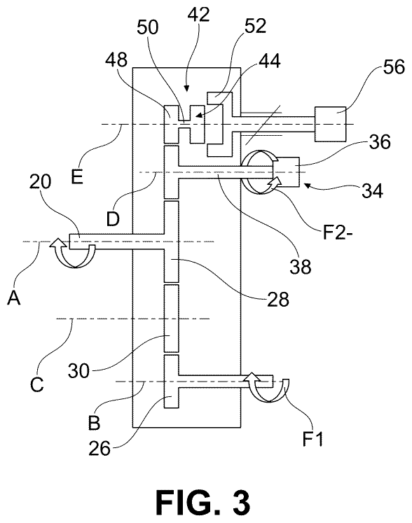

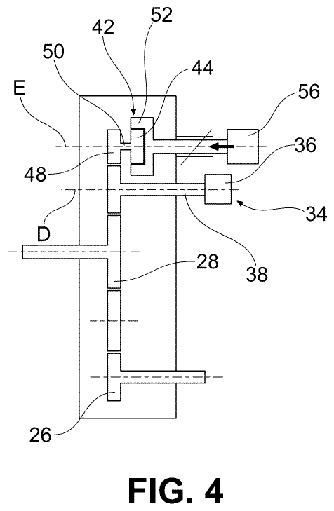

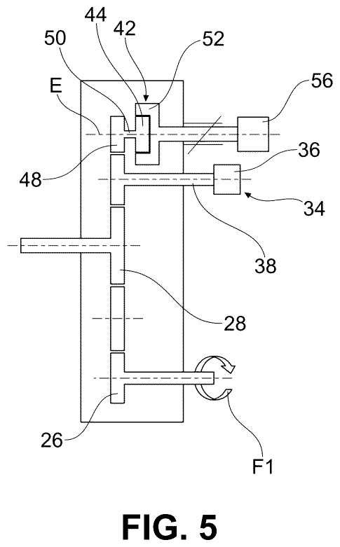

As the permanent magnets emit a permanent magnetic field, to enable the magnetic coupling device 42 to be controlled between its active and inactive states, the stator 52 is mounted so as to slide relative to the rotor 44 in the direction of the axis “E” of rotation between:
a spaced apart position, shown in FIGS. 2 and 3, corresponding to its inactive state, in which the first magnetic elements 46 are sufficiently separated from the second magnetic elements 54 for the resistive immobilization torque “Ci” to be substantially zero; and
a close position, shown in FIGS. 4 and 5, corresponding to its active state, in which the first magnetic elements 46 are sufficiently close to the second magnetic elements 54 for the resisting immobilization torque “Ci” to immobilise the rotating element 14 relative to the structural element 12.

In the embodiment shown in the figures, the stator 52 is mounted so that it can slide axially with respect to the structural element 12, while the rotor 44 remains axially fixed.

The sliding movement is controlled, for example, by a mechanical or electrical actuator 56.

Alternatively, the rotor 44 is mounted so that it can slide axially with respect to the structural element 12, while the stator 52 remains axially fixed.

In the active state, the first magnetic elements 46 are separated from the second magnetic elements 54 by an air gap “e”. In this position, the rotor 44 could rotate freely relative to the stator 52 if it were not prevented from doing so by the resistive holding torque “Ci”.

Alternatively, not shown, the first magnetic elements 46 and/or the second magnetic elements 54 are formed by electromagnets. In this case, the stator 52 can be axially fixed relative to the stator 52, the state of the magnetic coupling device 42 being controlled by the power supply to the electromagnets.

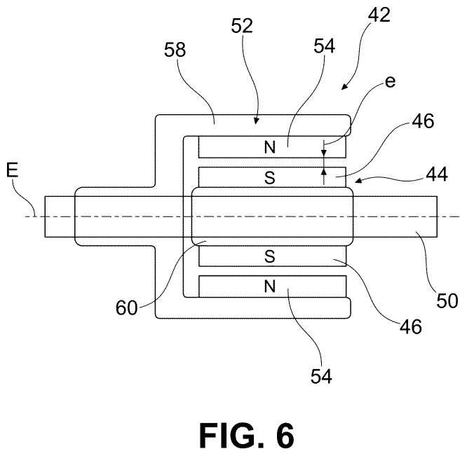

According to a first embodiment of the invention shown in FIGS. 2 to 7, the magnetic coupling device 42 is referred to as a “radial flux” device. In this case, when the magnetic coupling device 42 is in its active state, the first magnetic elements 46 of the rotor 44 are arranged radially opposite the second magnetic elements 54, with respect to the axis “E” of rotation, so that the mutual magnetic attraction force exerted by each first magnetic element 46 on the radially opposite second magnetic element 54 is radially oriented, as shown in FIG. 6.

To this end, the stator 52 has a tubular yoke 58, known as the external yoke 58. The rotor 44 has a cylindrical yoke 60, known as the internal yoke 60. Each yoke 58, 60, for example, is made of a ferromagnetic material.

In the close position, as shown in FIGS. 2, 3, 6 and 7, the inner yoke 60 is designed to be received concentrically inside the external yoke 58 with radial clearance so that no mechanical obstacle prevents rotation of the rotor 44 relative to the stator 52 about the axis “E” of rotation.

In the spaced apart position, as shown in FIGS. 2 and 3, the external cylinder head 58 is moved axially away from the internal cylinder head 60 so that the inner cylinder head 60 is no longer inside the external cylinder head 58.

In a variant not shown, and by mechanical inversion, the stator 52 comprises the internal yoke 60, while the rotor 44 has the external yoke 58.

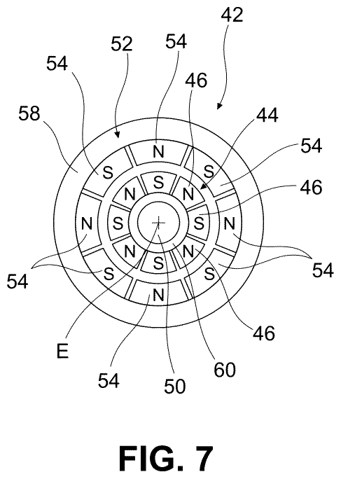

As shown in FIG. 7, the first magnetic elements 46 are arranged regularly around the axis “E” of rotation, in a ring gear in an inner cylindrical face of the external yoke 58. Each first magnetic element 46 is arranged so that one of its poles, known as the active pole, faces radially inwards. Two adjacent active poles have opposite polarities, as indicated by the references “N” and “S”. In this way, the first magnetic elements 46 are arranged in a ring gear around the axis “E” of rotation, alternating their polarity.

Similarly, the second magnetic elements 54 are arranged regularly around the axis “E” of rotation in a ring gear in an outer cylindrical face of the inner cylinder head 60. Each second magnetic element 54 is arranged so that one of its poles, known as the active pole, faces radially outwards. Two adjacent active poles have opposite polarities. The second magnetic elements 54 are arranged in a ring gear around the axis “E” of rotation with alternating polarity.

In the close position, the ring gear of first magnetic elements 46 is separated from the ring gear of second magnetic elements 54 by a radial air gap “e” shown in FIG. 6.

There are as many first magnetic elements 46 as there are second magnetic elements 54. Thus, when the stator 52 occupies its close position with respect to the rotor 44, the active pole of each first magnetic element 46 is associated with an active pole of opposite polarity of an associated second magnetic element 54. In this way, the force of mutual attraction between two opposing magnetic elements has a radial direction.

In addition, because of the alternating polarities of each active pole on the two ring gears, an active pole in one ring gear that is attracted by an active pole in the other ring gear is automatically repelled by the adjacent active poles of opposite polarities. This combination of attractive and repulsive forces produces a resistive torque “Ci” that allows the rotor 44 to be prevented from rotating relative to the stator 52.

Such a radial flux magnetic coupling device 42 has, for example, a slip torque “Cg” of between 40 and 100 N·m, for example 40 N·m or 95 N·m.

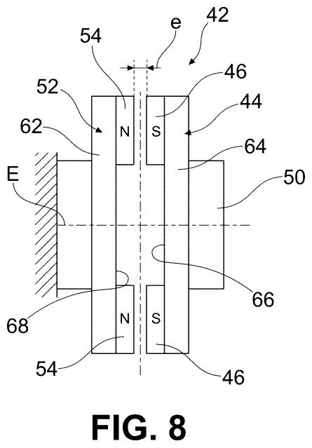

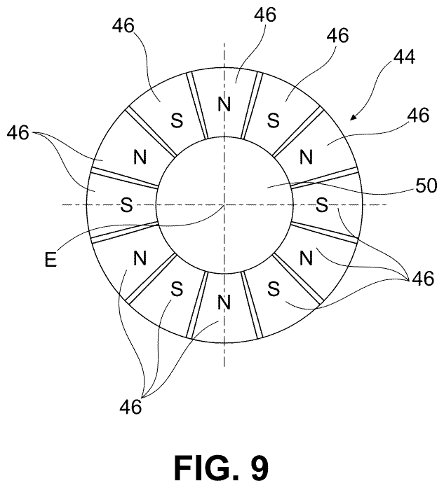

According to a second embodiment of the invention shown in FIGS. 8 and 9, the magnetic coupling device 42 is referred to as “axial flux”. In this case, when the magnetic coupling device 42 is in its active state, as shown in FIG. 8, the first magnetic elements 46 of the rotor 44 are arranged axially opposite the second magnetic elements 54 so that the mutual magnetic attraction force exerted by each magnetic element on the radially opposite magnetic element is oriented axially.

For this purpose, the stator 52 has a flange-shaped yoke 62 which extends radially around the axis “E” of rotation. The rotor 44 has a flange-shaped yoke 64 which extends radially around the axis “E” of rotation. The yoke 64 of rotor 44 thus has a free radial face 66 arranged opposite a free radial face 68 of the yoke 62 of the stator 52. Each yoke 62, 64, for example, is made of a ferromagnetic material.

In the close position, the free face 66 of the yoke 64 of the rotor 44 is intended to be arranged axially opposite the free face 68 of the yoke 62 of the stator 52 with axial clearance so that no mechanical obstacle prevents rotation of the rotor 44 relative to the stator 52 about the axis “E” of rotation.

In the spaced apart position, the face 66 of the yoke 64 of the rotor 44 is spaced axially from the face 68 of the yoke 62 of the stator 52.

As shown in FIG. 9, the first magnetic elements 46 are arranged regularly around the axis “E” of rotation, in a ring gear in the free face 66 of the yoke 64 of the rotor 44. Each first magnetic element 46 is arranged so that one of its poles, known as the active pole, is oriented axially towards the free face 68 of the yoke 62 of the stator 52. Two adjacent active poles have opposite polarities, as indicated by the references “N” and “S”. In this way, the first magnetic elements 46 are arranged in a ring gear around the axis “E” of rotation, alternating their polarity.

Similarly, the second magnetic elements 54 are arranged regularly around the axis “E” of rotation in a ring gear in the free face 68 of the yoke 62 of the stator 52. Each second magnetic element 54 is arranged so that one of its poles, known as the active pole, is oriented axially towards the free face 66 of the yoke 64 of the rotor 44. Two adjacent active poles have opposite polarities. The second magnetic elements 54 are arranged in a ring gear around the axis “E” of rotation with alternating polarity.

In the close position, the ring gear of first magnetic elements 46 is separated from the ring gear of second magnetic elements 54 by an axial air gap “e”, as shown in FIG. 8.

There are as many first magnetic elements 46 as there are second magnetic elements 54. Thus, when the stator 52 occupies its close position with respect to the rotor 44, the active pole of each first magnetic element 46 is associated with an active pole of opposite polarity of an associated second magnetic element 54. In this way, the force of mutual attraction between two opposing magnetic elements has an axial direction.

In addition, because of the alternating polarities of each active pole on the two ring gears, an active pole in one ring gear that is attracted by an active pole in the other ring gear is automatically repelled by the adjacent active poles of opposite polarities. This combination of attractive and repulsive forces produces a resistive holding torque “Ci”, preventing the rotor 44 from rotating in either direction relative to the stator 52.

Such an axial flux magnetic coupling device 42 has, for example, a sliding torque “Cg” of between 20 and 100 N·m, for example 20 N·m.

Regardless of how the synchronous magnetic coupling device 42 is constructed, each magnetic element 46, 54 is designed so that the strength of its magnetic field is great enough to prevent the rotating element 14 from rotating, whether under the effect of wind or any other force.

In addition to the fact that a magnetic coupling device 42 saves energy and reduces maintenance operations, the fact that immobilization is achieved without physical contact also prevents the immobilization means from being damaged when a rotational torque exceeding the sliding torque “Cg” of the magnetic coupling device 42 is applied to the rotating element 14. In this case, the rotor 44 will be rotated relative to the stator 52 without affecting the magnetic coupling device 42.

In addition, such a magnetic coupling device 42 is particularly compact and lightweight.

The operation of the turbine engine 10 is now described with reference to a radial flux magnetic coupling device 42. This description is also applicable to an axial flux magnetic coupling device 42.

As shown in FIG. 2, when it is necessary to drive the rotating element 14 in rotation, particularly during phases of flight, the means of immobilization by magnetic coupling device 42 are deactivated. In the example shown in the figures, the stator 52 is in its spaced apart position. In this way, the rotor 44 is free to rotate without the magnetic elements 46, 54 substantially impeding its rotation.

The propulsion means 22 drive the thrust-generating rotor 44 via the transmission housing 32, as indicated by arrow “F1”.

When the braking means 34 are formed by an electric braking motor 36 separate from the propulsion means 22, either the electric braking motor 36 can be used to supply a torque to assist the propulsion means 22, as indicated here by the arrow “F2+”, or the electric braking motor 36 is deactivated. In any case, the electric braking motor 36 does not provide a braking torque which opposes the rotation of the rotating element 14.

As shown in FIG. 3, when it is necessary to slow down the speed of rotation of the rotating member 14, for example when the aircraft is landed to quickly disembark passengers, the electric braking motor 36 is activated to provide a braking torque against the rotation of the rotating member 14 in order to slow down the rotating member 14, as indicated by FIG. “F2−”.

As shown in FIG. 4, when rotation of the rotating element 14 has been stopped, the means of immobilization by magnetic coupling device 42 are activated. The stator 52 is then controlled to slide axially from its spaced apart position to its close position. A resisting immobilizing torque “Ci” is then applied to the rotor 44, which immobilizes the rotating element 14 as long as the rotating element 14 is not subjected to a driving torque greater than or equal to the sliding torque “Cg”.

When the magnetic coupling device 42 is activated, the braking means 34 can be deactivated.

In this configuration, the propulsion means 22 can also be deactivated.

As shown in FIG. 5, during the next start, the magnetic coupling device 42 can remain activated and braking by the electric machine can be reactivated in order to draw electric or pneumatic power from the propulsion means 22 without driving the rotating element 14. In this case, care is taken to ensure that the driving torque transmitted by the propulsion means 22 to the rotor 44 is less than the slip torque “Cg”, adjusted for the transmission ratio.

1. A turbine engine for an aircraft, the turbine engine comprising:
a structural element;
a rotating element with blades or vanes rotatably mounted in the structural element and designed to generate thrust as the rotating element rotates;
propulsion means configured to drive the rotating element in rotation;
means for braking rotation of the rotating element formed by an electric braking motor;
controlled means for immobilizing the rotating element relative to the structural element;
wherein the controlled immobilization means are formed by a magnetic coupling device which is separate from the electric braking motor and which comprises:
a rotor mounted to rotate about an axis (E) of rotation, which is coupled to the rotating element, and which comprises first magnetic elements;
a stator mounted to be fixed in rotation about said axis (E) of rotation with respect to the structural element, and which comprises second magnetic elements;
the magnetic coupling device being controlled between an inactive state, in which the rotor is free to rotate relative to the stator, and an active state, in which the rotor is immobilized in rotation by an immobilizing resistive torque produced by magnetic interaction between the first magnetic elements and the second magnetic elements.

2. The turbine engine according to claim 1, wherein in the active state, the first magnetic elements are separated from the second magnetic elements by an air gap (e).

3. The turbine engine according to claim 2, wherein the first magnetic elements of the rotor are formed by permanent magnets.

4. The turbine engine according to claim 1, wherein the second magnetic elements of the stator are formed by permanent magnets.

5. The turbine engine according to claim 1, wherein the stator is mounted so as to slide with respect to the rotor in the direction of the axis (E) of rotation between:
a spaced apart position, corresponding to the inactive state, wherein the first magnetic elements are sufficiently separated from the second magnetic elements for the resistive immobilization torque to be zero; and
a close position, corresponding to the active state, wherein the first magnetic elements are sufficiently close for the immobilizing resistive torque to immobilize the rotating element relative to the structural element.

6. The turbine engine according to claim 1, wherein the first magnetic elements are arranged radially opposite the second magnetic elements when the magnetic coupling device is in the active state.

7. The turbine engine according to claim 6, wherein one of the stator or the rotor is configured to be received concentrically in the other of the stator or the rotor in the active state of the magnetic coupling device with reservation of a radial air gap (e), the first magnetic elements and the second magnetic elements each being arranged in a ring gear around the axis (E) of rotation, with their polarity alternating.

8. The turbine engine according to claim 5, wherein the first magnetic elements are arranged axially opposite the second magnetic elements when the magnetic coupling device is in the active state.

9. The turbine engine according to claim 8, wherein the rotor and the stator have the form of axially facing flanges, the first magnetic elements and the second magnetic elements each being arranged regularly about the axis (E) of rotation in the face facing the other flange.

10. The turbine engine according to claim 1, wherein the electric braking motor forms a propulsion means.
